(19) United States
(12) Patent Application Publication
(10) Pub. No.: US 2025/0217204 A1
(43) Pub. Date: Jul. 3, 2025

(54) METHODS AND APPARATUS FOR COMPUTING RESOURCE ALLOCATION

(71) Applicant: Telefonaktiebolaget LM Ericsson (publ), Stockholm (SE)

(72) Inventor: Zhongwen ZHU, Saint-Laurent, Quebec (CA)

(73) Assignee: Telefonaktiebolaget LM Ericsson (publ), Stockholm (SE)

(21) Appl. No.: 18/850,053

(22) PCT Filed: Apr. 25, 2022
(86) PCT No.: PCT/IB2022/053814

§ 371 Date: Sep. 24, 2024

(51) Int. Cl. G06F 9/50; G06F 11/34

(52) U.S. Cl. CPC G06F 9/5061; G06F 11/3409; G06F 2209/5013

(57) ABSTRACT

Methods and apparatus for computing resource allocation in a collaborative ML system are provided. A method for computing resource allocation comprises receiving, at a resource management controller, registration requests from one or more computing devices seeking to participate in the collaborative ML system, wherein the registration requests comprise smart contracts based on a blockchain system. The method further comprises registering the one or more computing devices, allocating computing resources provided by the devices to the collaborative ML system, and tracking the allocation of resources using the smart contracts. The method also comprises receiving updated information on at least one of: the available computing resources and the collaborative ML system resource requirements. The method further comprises updating the allocation of computing resources to the collaborative ML system based on the updated information, and tracking the updated allocation using the smart contracts.

### TECHNICAL FIELD

Embodiments described herein relate to methods and apparatus for computing resource allocation, in particular for computing resource allocation in a collaborative machine learning (ML) systems.

### BACKGROUND

Machine learning (ML) models, such as deep ML models, typically utilise data sets collected from environments the ML agent seeks to model, or environments similar to that the ML agent seeks to model. The data sets are commonly divided, such that different data from the data set may be used for training a ML model, validating the ML model, and testing the ML model. Through optimization processing, such as stochastic gradient descent (SGD) processing, the ML model may be trained and validated to converge to the desired/required accuracy level; the desired/required accuracy level is the accuracy level which is sufficient to effectively implement the purpose(s) of the ML model, for example, an accuracy level that can be applied for the prediction or inference on those test dataset. It is clear that access to suitable data, in sufficient quantities, is a key element when seeking to provide a ML model.

ML models are commonly trained at a central server; such central servers normally have large capacities in terms of computational power and memory storage. Where a central server is used as a training location, the data collected from an environment is usually sent to this central server. The data transfer operation(s) required to send the data to the central server may cause issues relating to the capacity (bandwidth) of a network used to transfer the data, the security and privacy of the data, and so on. Clearly privacy and security concerns for some forms of data are likely to be more acute, for instance patient medical history data is likely to require high levels of privacy and security.

When it is desired to avoid exposing raw data outside a local device (where the local device is a source of raw data and is typically part of the environment to be modelled) and at the same time it is desired to leverage the computational power and memory storage available to central servers, collaborative ML model training methods such as split learning may be implemented. In ML model training systems where split learning is implemented, at each round of training one or more local devices may train a ML model such as a neural network (NN) from the input layer up to a certain layer; the last layer trained at the local devices may be referred to as the cut layer, where the cut separates the layers trained at the local devices from the layers trained at the central server or servers. The outputs (latent data representation of the input dataset) from the cut layer may then be transmitted to the central server or servers where the training iteration for the remaining layers of the neural network may then be completed. The gradients resulting from the training iteration may then be propagated back through the layers until the server layer adjacent to the cut (that is, the last layer trained at the central server or servers). The server layer adjacent to the cut layer may then propagate the gradients from that layer back to the clients, without necessarily sending any further information from the other server layers (although in some implementations, additional information such as data labels may pass between the client devices and the central servers. Further training iterations may then be completed until the ML model achieves the desired level of accuracy. Split learning may therefore be used to effectively negate the requirement for client devices to provide private or high security data to a central device, while still allowing this data to be used for training purposes. An example of a system for implementing split learning is discussed in “Split learning for health: Distributed deep learning without sharing raw patient data” by Vepakomma, P. et al., 32^{nd} Conference on Neural Information Processing Systems, available at https://arxiv. org/pdf/1812.00564.pdf as of 22 Mar. 2022.

A further collaborative ML training method that may be implemented to obviate privacy and security issues arising from transferring raw data to central servers is federated learning. In federated learning systems, a plurality of client devices each train a ML model, such as a NN, using data available at the client device. That is, the client devices typically each complete a training iteration for a ML model using their own data.

The parameters of the ML model (weighs and biases) following the training iteration using the client device specific data may then be sent to a central server. The central server may then combine the data from the plurality of client devices to generate a unified (global) model; which may then be sent back to the client devices for a further training iteration. Various different algorithms may be used to combine the parameters from the client devices to generate the global model; a simple example algorithm combines the parameters using mean averaging, as discussed in “Communication-Efficient Learning of Deep Networks from Decentralized data” by McMahan, H. B. et al., AISTATS 2017, W&CP Vol. 54, available at https://arxiv.org/pdf/1602.05629.pdf as of 22 Mar. 2022. The parameter combination algorithm discussed in “Communication-Efficient Learning of Deep Networks from Decentralized data” is commonly referred to as federated averaging. Other parameter combination algorithms may also be used in federated learning systems, including “FedProx”, “FedMa”, “FedOpt”, “Scaffold”, and so on (all as discussed in “Advances and Open Problems in Federated Learning” by Kairouz, P. et al., Foundations and Trends in Machine Learning Vol. 4, Iss. 1, available at https://arxiv.org/abs/1912.04977 as of 22 Mar. 2022.

Collaborative learning systems require cooperation between at least two devices (a client device and a server), and typically involve more than two devices. It is common for devices operated by different users to be involved in collaborations, for example, where the environment to be modelled is all or part of a communications network, the client devices may be, or may be connected to, network nodes that are operated by different service providers. On occasion, trained ML models that have been generated by collaborative learning systems may also be utilised by client devices that did not participate in the collaboration (for example, did not provide data). Further, the computing resource requirements of collaborative learning systems (such as processing resources, memory resources, and so on) typically vary with time; taking the example of a federated learning system, the processing requirements of the central server while combining the local models are likely to be significantly higher than when the local models are being trained at client devices and the central server is idle.

It is desirable to provide a system for apportioning computing resources necessary for collaborative learning systems to operate, while additionally or alternatively tracking contributions made to collaborative learning systems. It is further desirable to facilitate the participation in collaborative learning systems of different resources having different levels of trust, different data sources, and so on in an efficient way in order to have a low impact on the collaborative learning system and environment.

### SUMMARY

It is an object of the present disclosure to provide methods, apparatus and computer-readable media which at least partially address one or more of the challenges discussed above. In particular, it is an object of the present disclosure to provide computing resource allocation methods and apparatuses that efficiently allocate resources and track resource allocation in collaborative ML systems, including systems utilising distributed learning techniques such as one or more of split learning and federated learning.

An embodiment provides a method for computing resource allocation in a collaborative ML system. The method comprises receiving, at a resource management controller, registration requests from one or more computing devices seeking to participate in the collaborative ML system, wherein the registration requests comprise smart contracts based on a blockchain system. The method further comprises registering the one or more computing devices, allocating computing resources provided by the one or more computing devices to the collaborative ML system, and tracking the allocation of resources using the smart contracts. The method also comprises receiving updated information on at least one of: the available computing resources provided by the one or more computing devices, and the collaborative ML system resource requirements. Based on the updated information, the method comprises updating the allocation of computing resources to the collaborative ML system and tracking the updated allocation of resources using the smart contracts.

A further embodiment provides a resource management controller for computer resource allocation in a collaborative ML system. The resource management controller comprises processing circuitry, one or more interfaces and a memory containing instructions executable by the processing circuitry. The resource management controller is operable to receive registration requests from one or more computing devices seeking to participate in the collaborative ML system, wherein the registration requests comprise smart contracts based on a blockchain system. The resource management controller is further operable to register the one or more computing devices, allocate computing resources provided by the one or more computing devices to the collaborative ML system, and track the allocation of resources using the smart contracts. The resource management controller is also operable to receive updated information on at least one of: the available computing resources provided by the one or more computing devices, and the collaborative ML system resource requirements, and update the allocation of computing resources to the collaborative ML system based on the updated information. The resource management controller is also operable to and track the updated allocation of resources using the smart contracts.

Further embodiments provide systems comprising resource management controllers as defined herein, and computer-readable media comprising instructions which when executed on a computer, cause the computer to perform methods as defined herein.

### BRIEF DESCRIPTION OF DRAWINGS

The present disclosure is described, by way of example only, with reference to the following figures, in which:—

FIG. 1 is a flowchart of a method in accordance with embodiments;

FIG. 2A is schematic diagram of a resource management controller in accordance with embodiments;

FIG. 2B is schematic diagram of a further resource management controller in accordance with embodiments;

FIG. 3 is a schematic diagram of a system comprising a resource management controller in accordance with embodiments;

FIGS. 4A to 4D show a signalling diagram showing an example of the implementation of methods in accordance with embodiments.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

To support the processes involved in the registration, monitoring, deregistration, and so on of resources and data that may be used in collaborative learning systems, embodiments may utilise smart contracts based on blockchain systems. Blockchains systems are distributed software networks that provide digital ledger functionality, allowing retention and validation of transactions occurring in the network. A blockchain is essentially a series of digital records (blocks), each of which is time stamped and contains a cryptographic hash function of the previous block in the chain. As each block in the chain contains information on the previous blocks, the addition of blocks to the chain increases the security of existing blocks. This is because, for a chain comprising blocks 1 to n where n is the most recently added block, it is not possible to retroactively edit block x in the chain in a way that would be validated without also editing all subsequent blocks between x+1 and n. In a specific example, if n=20, retroactively editing block 4 (x=4) would require all blocks 5 to 20 to also be edited. Any attempt to edit block x without also editing all blocks x+1 to n would be immediately detected the next time the block chain was validated or updated (added to). The blocks are transmitted between nodes in the distributed software network, each of which maintains a database of the blockchain that is periodically validated and updated. Accordingly, to retroactively edit the block chain would require all subsequent blocks, in all nodes, to be essentially simultaneously edited; the difficulty of achieving this task is the basis for the security provided by blockchain systems. Embodiments may utilise public or private blockchain systems, or systems combining public and private aspects.

Smart contracts are programs that run on blockchains, essentially constituting collections of code and data that resides at a specific address on a blockchain. Smart contracts may be utilised to perform tasks related to a system using a block chain, for example, retrieving data from a device (such as a client device) and passing the data to a further device (such as a central server).

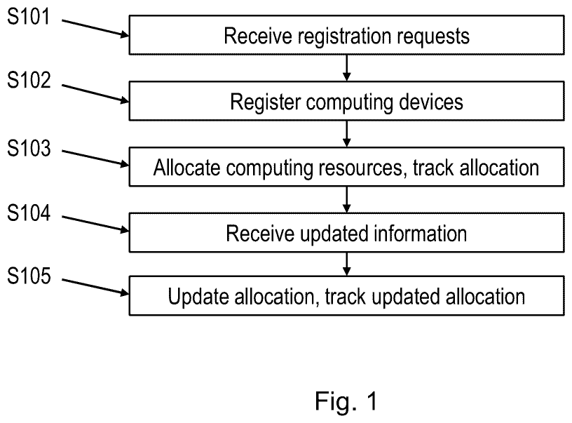

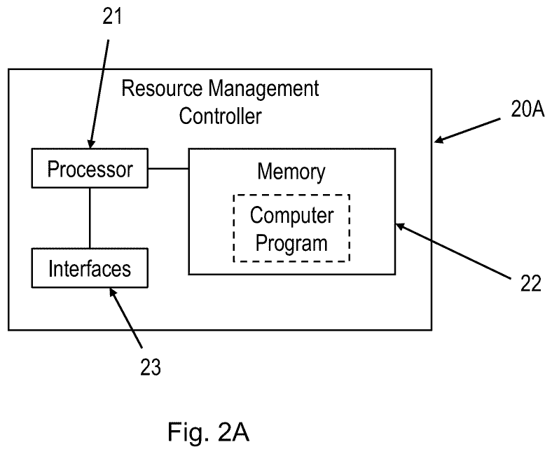

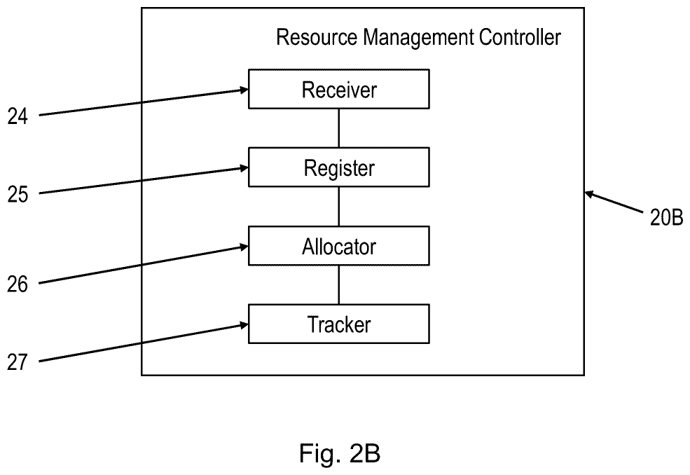

A computer-implemented method in accordance with embodiments is illustrated by FIG. 1, which is a flowchart showing a method for computing resource allocation in a collaborative ML system. The computer-implemented method may be performed by any suitable apparatus or apparatuses, for example, by a resource management controller 20A, 20B (collectively 20) such as those shown in FIG. 2A and FIG. 2B. By way of example, where the method is implemented in a communications network (or part of the same), the method may be performed by an apparatus (such as a resource management controller) that is or forms part of a base station or core network node (or may be incorporated in a base station or core network node). The communications network may be a 5G network as discussed above, and may or may not incorporate Internet of Things (IoT) devices. Further, the base station may be a gNB. As an alternative example, where the method is implemented in a medical facility, the apparatus may be or form part of a records management system responsible for control of medical records used in the facility.

As shown in step S102 of FIG. 1 the method comprises receiving, at a resource management controller, registration requests from one or more computing devices seeking to participate in the collaborative ML system, wherein the registration requests comprise smart contracts based on a blockchain system. In some embodiments a smart contract may be deployed (for example, by a resource management controller) onto a network via a public or private blockchain; this deployment may take place prior to the receipt by the resource management controller of any registration requests. Where a smart contract is deployed onto a network, this smart contract may be deployed in response to receipt from a user of a request for a trained specific ML model, wherein the specific ML model is to be trained using the collaborative ML system; where this is the case the deployed smart contract may be a model delivery smart contract seeking resources specifically for use in generating the specific ML model requested by the user.

The registration requests may include information relating to the computing devices responsible for sending the requests. Where provided, this information may be used by the resource management controller when determining allocation of resources to the collaborative ML system. The exact nature of the information provided is determined in part by the nature of the computing device providing the information and by the information required by the resource management controller (in some embodiments, a deployed smart contract may specify what information on the computing devices should be provided in the registration request). Examples of the information on the computing devices include: a device type of the computing device; a computation capacity of the computing device; a storage capacity of the computing device; a network interface capacity of the computing device; a physical location of the computing device; a type of energy used to power the computing device; and an availability of the computing device. Expanding upon the first type of information set out above, the device type may be, for example, an IoT device, a database or data storage facility, a server (such as an edge server), a cloud computing facility, a base station or other network node, a user equipment (UE), and so on. As will be appreciated by those skilled in the art, each of these device types would have different storage (memory) capacities, different computation (processing) capacities, and so on. Further, some devices may be configured such that they can accept external processing jobs or memory storage requests, and some may not. Where information on the type of energy used by a computing device is provided, this may be used to determine which of a number of otherwise similar resources should be used to perform a task. By way of example, where a pair of otherwise similar devices exist, one of which is battery powered and the other of which is connected to mains power, the mains powered device is less restricted in terms of power usage and may therefore be favoured. Information on the type of energy used may also be used to reduce the environmental impact of the system, for example, where a pair of otherwise similar resources are available, one of which is powered by a renewable energy source such as solar energy and the other of which is powered by a non-renewable energy source such as oil, the device powered by a renewable energy source may be favoured. The step of receiving the registration requests may be performed in accordance with a computer program stored in a memory 23, executed by a processor 21 in conjunction with one or more interfaces 22, as illustrated by FIG. 2A. Alternatively, the step of receiving the registration requests may be performed by receiver 44 as shown in FIG. 2B.

When the registration request has been received, the resource management controller may send requests for additional information (which may comprise updated information) to computing devices if desired. The resource management controller may reject registration requests where, for example, computing devices seeking to register are untrusted or there is a surplus of a particular type of device already registered. However typically the resource management controller will register the one or more computing devices, as shown in step S104 of FIG. 1. The step of registering the computing devices may be performed in accordance with a computer program stored in a memory 23, executed by a processor 21 in conjunction with one or more interfaces 22, as illustrated by FIG. 2A. Alternatively, the step of registering the computing devices may be performed by register 25 as shown in FIG. 2B.

Following the registration of the one or more computing devices, the resource management controller may then configure the collaborative ML system. The specific details of the configuration of the collaborative ML system vary depending on the type of collaborative ML to be used, for example, the configuration details for split learning systems are different to those for federated learning systems (some collaborative ML systems may use both split learning and federated learning, and other collaborative ML techniques may also be used). In some embodiments the collaborative ML system is configured by a further apparatus or system separate from the resource management controller; where this is the case, the resource management controller may be sent details of the collaborative ML system configuration such that it may allocate resources appropriately. A more detailed discussion of collaborative ML system configuration can be found below.

As shown in FIG. 1 at step S103, the resource management controller allocates computing resources (processor time, memory capacity, and so on) provided by the one or more computing devices to the collaborative ML system. The resource management controller also tracks the allocation of resources using the smart contracts. The step of allocating computing resources and tracking the allocation may be performed in accordance with a computer program stored in a memory 23, executed by a processor 21 in conjunction with one or more interfaces 22, as illustrated by FIG. 2A. Alternatively, the step of allocating computing resources and tracking the allocation may be performed by allocator 26 and tracker 27 as shown in FIG. 2B.

Where the collaborative learning system involves training of a ML model being undertaken by the one or more computing devices (as is typically the case for both split learning and federated learning systems), the allocation of resources may comprise sending ML model information to the one or more computing devices for training; this ML model information may comprise an initial ML model with untrained weights and biases, for example. The sending of the ML model information may be tracked using the smart contracts, as discussed above. In some embodiments the computing resources to be used in ML model training may be dispersed across a number of devices and/or may be cloud resources; where this is the case, again the relevant information is sent to the one or more resources and tracked using smart contracts. By way of example, a UE may be providing data for use in a federated learning system, but the actual training of the ML model using the UE data may be undertaken by a server; the server may have greater processing resources and may therefore be better suited to this role. Accordingly, smart contracts may be used to track the sending of data by the UE to the server, the training of the ML model at the server using the UE data, and the subsequent sending of the ML model after the training iteration to the central server for use in the generation of the global ML model.

Subsequent to the step of allocating resources to the collaborative ML system, the resource management controller receives updated information on at least one of the available computing resources (provided by the one or more computing devices), and the collaborative ML system resource requirements, as shown in step S104 of FIG. 1. The step of receiving updated information may be performed in accordance with a computer program stored in a memory 23, executed by a processor 21 in conjunction with one or more interfaces 22, as illustrated by FIG. 2A. Alternatively, the step of receiving updated information may be performed by receiver 24 as shown in FIG. 2B.

The updated information may indicate, for example, that a training iteration has been completed; this may comprise an indication that a central server has generated an updated global ML model in a federated learning system and is ready to distribute the updated global ML model to client devices for a further training iteration, for example. The updated information may additionally or alternatively indicate, for example, an update in the availability of computing resources. By way of example, the updated availability may indicate that a server that has previously provided computing resources for the collaborative ML system will no longer be available, that is, in the future does not wish to provide resources for the collaborative ML system. As a further example, the updated availability may indicate that a UE or IoT device which has not previously participated in the collaborative ML system seeks to participate in the future. The updated information may be received by the resource management controller from one or more of the computing devices without the resource management controller specifically prompting the computing devices providing the updated information to send such information, for example, a computing device may access a smart contract made available on a network and send a registration request to the resource management controller. Alternatively, in some embodiments the resource management controller may monitor some or all of the computing devices that have indicated (via registration) an interest in participating in the collaborative ML system. The monitoring may comprise, for example, receiving Key Performance Indicator (KPI) information such as transmission lag times, buffer capacity, and so on from the computing devices on request or on a periodic schedule. Where the resource management controller monitors some or all of the computing devices to obtain updated information, this may support the resource management controller in responding to changes in the availability of computing resources. By way of example, if the resource management controller monitors KPIs of plural computing devices that have registered to provide storage capacity to the collaborative ML system, should one of the computing devices indicate no future availability to provide resources, the resource management controller may use the information on KPIs of the computing devices to quickly allocate further computing devices to compensate for the computing device with no future availability.

When the resource management controller has received the updated information, the resource management controller then updates the allocation of computing resources to the collaborative ML system based on the updated information, and tracks the updated allocation of resources using the smart contracts, as shown in step S105 of FIG. 1. The step of allocating of computing resources to the collaborative ML system based on the updated information, and tracking the updated allocation of resources using the smart contracts may be performed in accordance with a computer program stored in a memory 23, executed by a processor 21 in conjunction with one or more interfaces 22, as illustrated by FIG. 2A. Alternatively, the step of allocating of computing resources to the collaborative ML system based on the updated information, and tracking the updated allocation of resources using the smart contracts may be performed by the allocator 26 and tracker 27 as shown in FIG. 2B. Following the allocation and tracking of resources, the one or more computing resources allocated to the collaborative ML system may perform tasks, for example, a training iteration may be completed. The resource management controller may receive further updated information on one or both of available computing resources and collaborative ML system resource requirements, and may then update allocation of resources and track the updated resources. This process may be repeated until the ML model trained using the collaborative ML system reaches a desired/required level of accuracy (that is, a predetermined accuracy threshold), at which time the ML model training may be considered complete.

The determination that a ML model trained using the collaborative ML system has reached a predetermined accuracy threshold and is therefore sufficiently trained may be made by the resource management controller in some embodiments. Typically, the determination is made by a further component of the collaborative ML system, for example, a central server as may be used in a federated learning or split learning system may make the determination. In embodiments where the determination is made other than by the resource management controller, the resource management controller may receive a determination that the accuracy of a ML model trained using the collaborative ML system has reached a predetermined threshold accuracy. In response to receiving the determination, the resource management controller may itself store, or instruct the storage of, the ML model in a suitable database. Additionally or alternatively, where the ML model is a specific ML model that was trained in response to receipt from a user of a request for a trained specific ML model (as discussed above), the resource management controller may provide the trained specific ML model to the user that requested it when a determination is made (either by the resource management controller or otherwise) that the ML model has reached the predetermined accuracy threshold.

In embodiments wherein the collaborative ML system utilises split learning, the configuring of the collaborative ML system (whether done by the resource management controller or elsewhere) may comprise determining a cutting layer, and communicating the cutting layer to the one or more computing devices participating in the collaborative ML system. Subsequently, updated information received by the resource management controller may comprise an indication that a training iteration has been completed. In response to receiving an indication that a training iteration has been completed, the resource management controller may update the allocation of computing resources for a next training iteration, this update may comprise sending updated device and ML model information to be used for a next training iteration, for example, sending a new cut layer location for use in a next training iteration.

In some embodiments, additionally or alternatively to using split learning, a collaborative ML system may used federated learning. Where the collaborative ML system uses federated learning, the configuration of the collaborative ML system may comprise identifying, among the plurality of computing devices, at least one client device for performing local ML model training and at least one leader device for performing global model derivation. Further, updated information received by the resource management controller may comprise an indication that a training iteration has been completed. In response to receiving an indication that a training iteration has been completed, the resource management controller may update the allocation of computing resources for a next training iteration, this update may comprise sending updated device and ML model information (for example, an updated global model) to be used for a next training iteration, for example, sending identities for at least one leader device and at least one client device for use in a next training iteration.

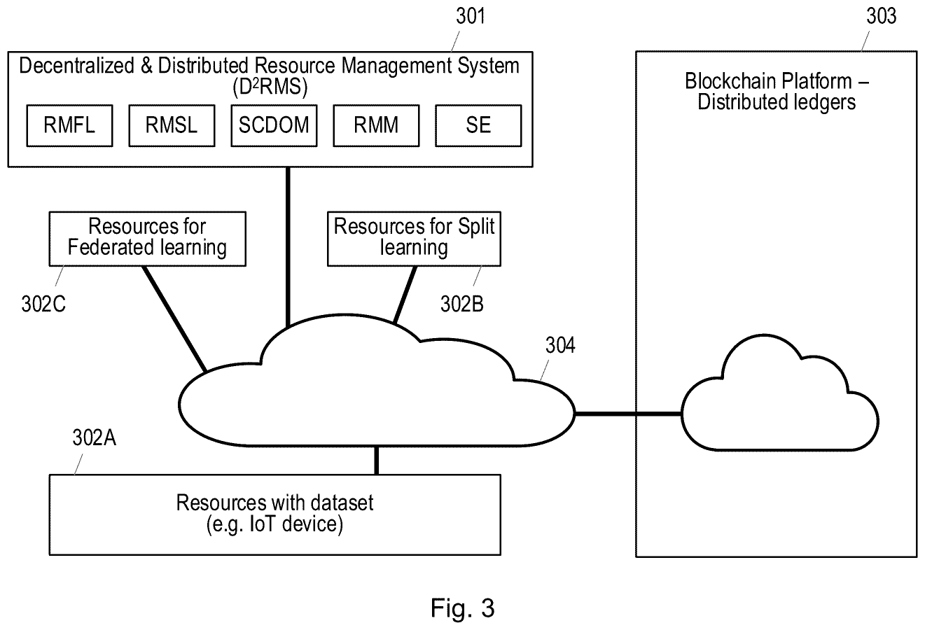

FIG. 3 is a diagram showing a system comprising a resource management controller in accordance with embodiments. In the system shown in FIG. 3, the resource management controller is distributed across a number of modules, wherein the different modules may be hosted in different computing devices (including in cloud systems). Accordingly, the resource management controller in FIG. 3 may be referred to as a distributed resource management system (DRMS). Further, as the resource management controller shown in FIG. 3 uses a decentralised architecture, with no central controlling apparatus having a controlling role over the other apparatuses, the resource management controller in FIG. 3 may be referred to as a decentralised and distributed resource management system (DDRMS or D²RMS) 301. Also shown in FIG. 3 are three groups of resources; the three groups of resources are shown separately in FIG. 3 for simplicity, in some embodiments the groups of resources may overlap. One of the three groups of resources comprises resources having datasets that may be used in the training of a ML model; these are the resources with the dataset 302A and may comprise, for example IoT devices. A second of the three groups of resources comprises resources for use in split learning 302B, and a third of the three groups of resources comprises resources for use in federated learning 302C. Both the split learning resources and federated learning resources may comprise, for example, servers providing processing resources, databases providing memory resources, and so on. FIG. 3 also includes a network 303 (which may be a public network, a private network, or a network having both public and private elements) that supports a blockchain based distributed ledger system. Also shown in FIG. 3 is a network 304 (such as a communications network) providing connections between the D²RMS and the various resources.

The D²RMS 301 shown in FIG. 3 comprises a plurality of modules; the modules act together to perform resource allocation control as discussed above, including performing the method shown in FIG. 1. In the D²RMS 301 shown in FIG. 3, the modules comprise a Resource Manager for Federated Learning (RMFL), a Resource Manager for Split Learning (RMSL), a Resource Monitoring Manager (RMM), a Service Configuration and Deployment Orchestration Manager (SCDOM) and a Service Exposure (SE) module. D²RMS in accordance with other embodiments may omit one or more of these modules, and may also comprise additional modules. The D²RMS may also comprise and/or have access to database storage, which may be used to store information related to models, smart contracts, registered resources, resource statuses, and so on. Further, in some embodiments, D²RMS agents may be installed on computing devices that have registered to participate in collaborative ML systems; these agents may be used to communicates with the D²RMS to provide device information, and may additionally or alternatively receive information to configure or re-configure computing device parameters for different distributed machine learning.

The RMFL may be used, where federated learning is to be employed, to manage the resources involved in the federated learning system. By way of example, the RMFL may be used to select computing resources to implement model training, said selection being made using an optimization algorithm or model, for example. When selecting the computing resources, information on computing devices such as network topology information, network status information (bandwidth, availability, reliability, etc.), types of energy used by computing devices, and so on may be inputs into the algorithm or model used. The RMSL may provide similar functions to the RMFL where split learning is to be employed. By way of example, the RMSL may be used to manage the resources involved in local model training. The RMSL may select computing resources at network edges to offload the computation for model training. The distribution of the model training between the computing devices with dataset and computing devices providing processing and/or memory resources may be done through the cut layer, which may be decided by the D²RMS or by another component (such as one of the computing resources) based on factors such as: available computational capacity at resources, available memory storage at resources, the size of the data at cut layer (that is, the latent representation, the number of data samples, and so on), the location of the involved computing resources, the network status (bandwidth, availability, reliability, and so on), types of energy used by computing devices, and so on.

The RMM may be used to monitor computing resources registered through the smart contract, and to provide information obtained through the monitoring to other modules, such as the RMFL, RMSL and/or SCDOM. The SCDOM may be used to orchestrate computing resource selection based on information from one or more of the RMFL, RMSL and RMM. Additionally, the SCDOM may be used to manage the smart contracts used for computing device registration and so on. The SE module may be used to allow connections between one or more Application Program Interfaces (API) of the D²RMS and other network components.

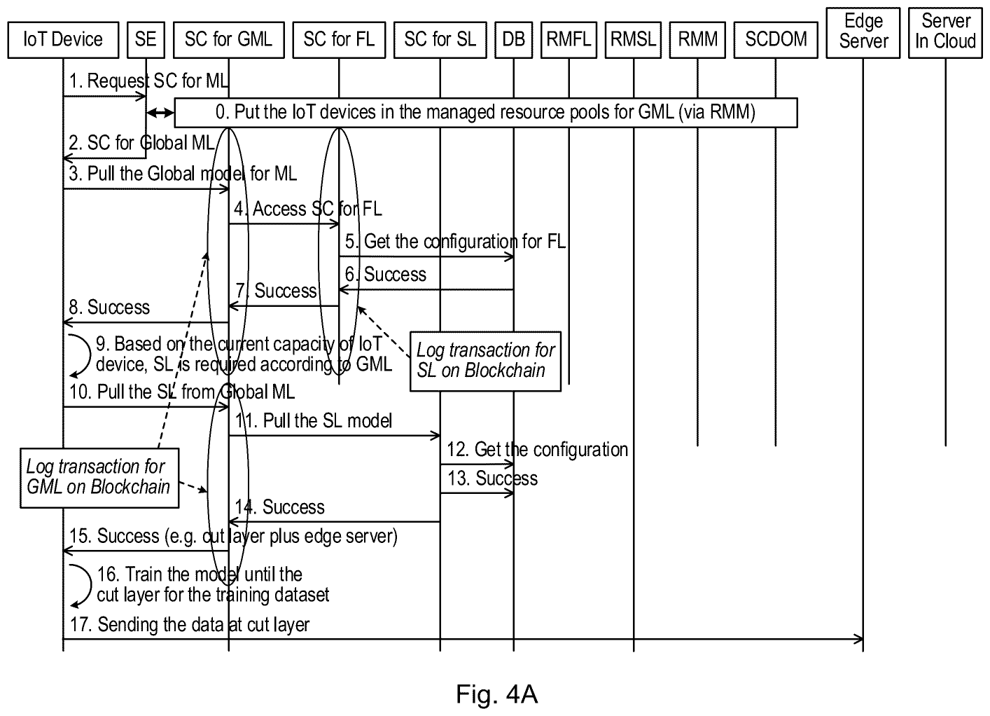

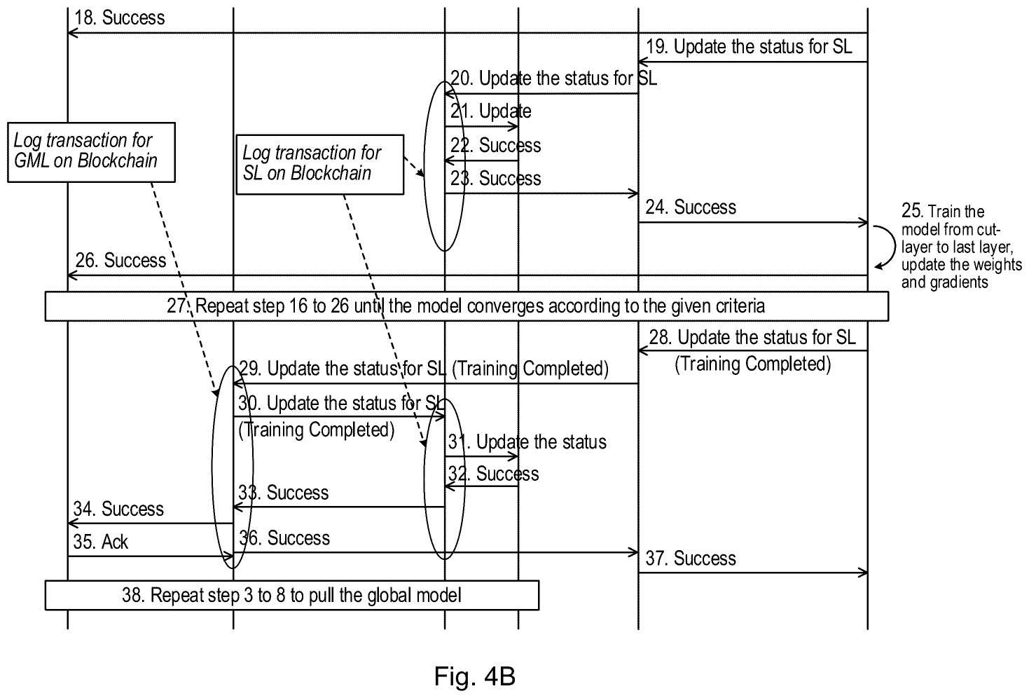

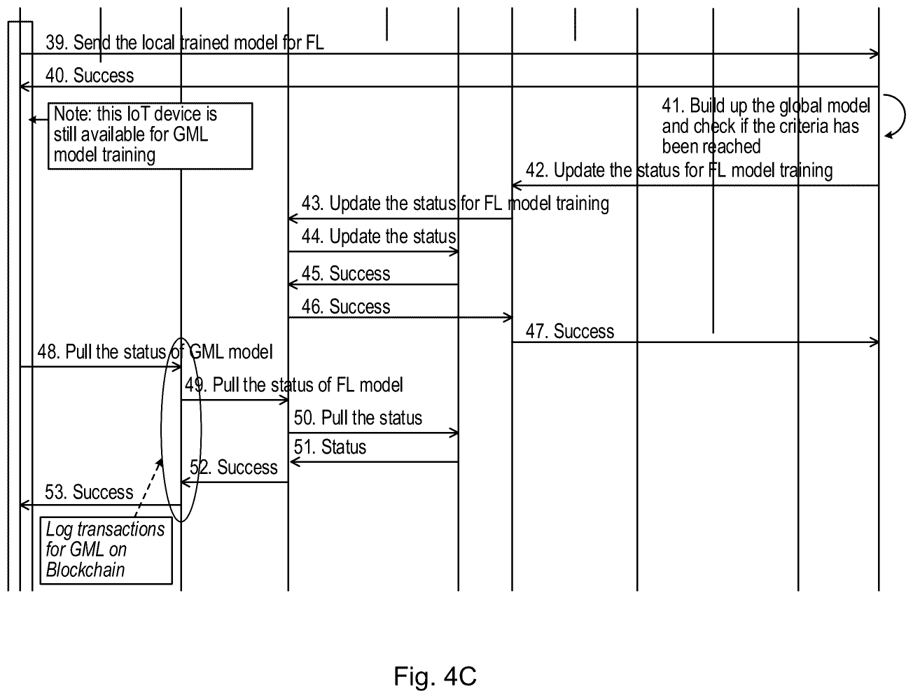

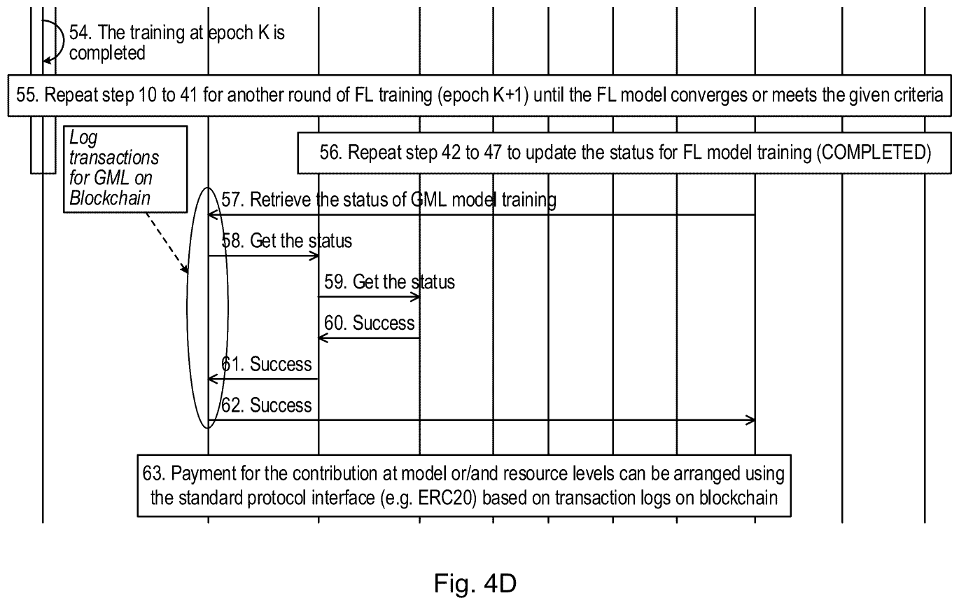

FIG. 4A to FIG. 4D (collectively FIG. 4) show a signalling diagram showing an example implementation. In the example implementation shown in FIG. 4, a combination of split and federated learning is used; as discussed above alternative ML training techniques may additionally or alternatively be used. The FIG. 4 example implementation utilises the system shown schematically in FIG. 3; alternative implementations may utilise the systems of FIG. 2A or 2B, or any other suitable system.

In step 1 of FIG. 4, a user (here represented by an IoT device) submits a request for a trained specific ML model (here referred to as the Global ML, GML, model) via the SE of the D²RMS. In response, a smart contract for the generation of the GML is generated (step 2); in the FIG. 4 example implementation this smart contract specifies the criteria (for example, accuracy) to be satisfied by the GML model. Registered IoT devices are assigned to managed resource pools by the RMM (step 0), and a generic ML model to be trained as the GML model is retrieved from a database and configured (steps 3 to 8); these transactions are recorded on the blockchain. As a consequence of the computing capabilities of the IoT device, it is necessary to utilise split learning, essentially to allow some of the computing intensive tasks to be carried out in resources other than the IoT devices (step 9). Accordingly, in steps 10 to 15, a SL system is configured; the SL training is overseen by the RMSL of the D²RMS. At step 16, the IoT device trains the ML model, using data available to the IoT device (that is, local data), to the cut layer. The output (data representation) at the cut layer is then sent to an edge server for further training, after which the gradients and weights resulting at the cut layer from the training are sent back to the IoT devices (steps 17 to 26). Suitable records of the SL training are maintained throughout the training process on the blockchain, as shown in FIG. 4. Further training iterations are completed until the accuracy of the ML model reaches a predetermined accuracy threshold (step 27). When the predetermined accuracy threshold is reached, the training of the ML model with the IoT device data and using SL is deemed to be complete. The smart contracts are updated appropriately (steps 29 to 37).

When the model trained using the IoT device data (hereinafter referred to as the local model) has reached the predetermined accuracy threshold, the local model may then be utilised as an input to a FL system. At steps 38 to 40, the local model is sent to a cloud server as an input to a FL system; the FL training is overseen by the RMFL of the D²RMS. The cloud server generates a unified model using the input local model from the IoT device and other local models from other client devices (step 41; the other client devices may be further IoT devices, for example). The generated unified model is then distributed back to the client devices (including the IoT device) for further training, and the blockchain is updated accordingly (steps 42 to 54). In particular, the status of the unified model trained using the FL system is checked against the smart contract for the GML model as shown in steps 48 and 49. As indicated in FIG. 4 (step 55), steps 10 to 41 may then be repeated for each training iteration of the FL system, until the model trained by the FL system satisfies the criteria set out in the smart contract for the GML model. When the criteria are satisfied, the GML model has been generated and further training iteration are not required. Steps 42 to 47 are repeated to indicate the completion of the FL model training as shown in step 56, and the GML model may then be delivered to the requesting user (that is, the user of the IoT device) or to another device. In the example implementation shown in FIG. 4, the blockchain records of the contributions to the SL and FL training processes by computing devices (such as the edge server and cloud server, for example) may then be used to apportion payment, as shown in steps 57 to 63.

Embodiments may provide systems for apportioning computing resources necessary for collaborative learning systems to operate, while additionally or alternatively tracking contributions made to collaborative learning systems. In addition to facilitating participation in collaborative learning systems of different resources having different levels of trust, different data sources, and so on in an efficient way, embodiments may support said participation with a low impact on the collaborative learning system and environment. Embodiments provide support for AI/ML model training using different devices contributed by different owners at different location and different time windows to meet the increasing demands from a range of applications. Use of embodiments may support the efficient usage of the registered resources by considering the workload, storage, location, network connectivity, different types of energy consumption, and so on of resources in order to minimize the impact on the overall network as well as the environment.

In some embodiments where a distributed or decentralized system is utilised, in conjunction with smart contracts (supported by blockchain), the barriers to participation for owners of small or medium sized resources may be reduced relative to existing systems, thereby increasing the utilisation of said resources. Access to global machine learning model training processes that require large amounts of computational capacity and storage is also improved.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some embodiments may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A method for computing resource allocation in a collaborative machine learning, ML, system, the method comprising:
receiving, at a resource management controller, registration requests from one or more computing devices seeking to participate in the collaborative ML system, wherein the registration requests comprise smart contracts based on a blockchain system;
registering the one or more computing devices;
allocating computing resources provided by the one or more computing devices to the collaborative ML system, and tracking the allocation of resources using the smart contracts;
receiving updated information on at least one of: the available computing resources provided by the one or more computing devices, and the collaborative ML system resource requirements; and
updating the allocation of computing resources to the collaborative ML system based on the updated information, and tracking the updated allocation of resources using the smart contracts.

2. The method of claim 1, wherein the one or more registration requests comprise information on the computing devices.

3. The method of claim 2, wherein the information on the computing devices comprises at least one of:
a device type of the computing device;
a computation capacity of the computing device;
a storage capacity of the computing device;
a network interface capacity of the computing device;
a physical location of the computing device;
a type of energy used to power the computing device; and
an availability of the computing device.

4. The method of claim 2 further comprising, following the receipt of the registration requests, configuring the collaborative ML system.

5. The method of claim 4, wherein the collaborative ML system utilizes split learning, and wherein:
the configuration of the collaborative ML system comprises determining a cutting layer, and communicating the cutting layer to the one or more computing devices participating in the collaborative ML system;
the updated information on the collaborative ML system resource requirements comprises an indication that a training iteration has been completed; and
the updated allocation of computing resources to the collaborative ML system comprises updated device and ML model information to be used for a next training iteration.

6. The method of claim 4, wherein the collaborative ML system utilizes federated learning and the one or more computing devices comprise a plurality of computing devices, and wherein:
the configuration of the collaborative ML system comprises identifying, among the plurality of computing devices, at least one client device for performing local ML model training and at least one leader device for performing global model derivation;
the updated information on the collaborative ML system resource requirements comprises an indication that a training iteration has been completed; and
the updated allocation of computing resources to the collaborative ML system comprises updated device and ML model information to be used for a next training iteration.

7. The method of claim 1, wherein the resource management controller monitors the one or more computing devices to receive the updated information.

8. The method of claim 7, wherein the monitoring comprises receiving one or more Key Performance Indicators, KPI, from the one or more computing devices.

9. The method of claim 1 further comprising receiving a determination that the accuracy of a ML model trained using the collaborative ML system has reached a predetermined threshold accuracy.

10. The method of claim 8 further comprising, when the ML model is determined to have reached the predetermined accuracy threshold, storing the ML model in a database.

11. The method of claim 9 further comprising:
receiving a request from a user for a trained specific ML model, wherein the specific ML model is to be trained using the collaborative ML system, and deploying a model delivery smart contract; and
when the specific ML model is determined to have been trained to reach the predetermined accuracy threshold, providing the trained specific ML model to the user.

12. The method of claim 1, wherein the one or more computing devices comprise at least one of:
an Internet of Things, IoT, device;
an edge server; and
a database.

13. The method of claim 1, wherein at least one of the one or more computing devices is part of a communications network.

14. A resource management controller for computer resource allocation in a collaborative machine learning, ML, system, the resource management controller comprising processing circuitry, one or more interfaces and a memory containing instructions executable by the processing circuitry, whereby the resource management controller is operable to:
receive registration requests from one or more computing devices seeking to participate in the collaborative ML system, wherein the registration requests comprise smart contracts based on a blockchain system;
register the one or more computing devices;
allocate computing resources provided by the one or more computing devices to the collaborative ML system, and track the allocation of resources using the smart contracts;
receive updated information on at least one of: the available computing resources provided by the one or more computing devices, and the collaborative ML system resource requirements; and
update the allocation of computing resources to the collaborative ML system based on the updated information, and track the updated allocation of resources using the smart contracts.

15-24. (canceled)

25. A collaborative machine learning, ML, system comprising a resource management controller for computer resource allocation and one or more computing devices, wherein the one or more computing devices comprise at least one of:
an Internet of Things, IoT, device;
an edge server; and
a database,
wherein the resource management controller comprises processing circuitry, one or more interfaces and a memory containing instructions executable by the processing circuitry, whereby the resource management controller is operable to:
receive registration requests from the one or more computing devices, wherein the registration requests comprise smart contracts based on a blockchain system;
register the one or more computing devices;
allocate computing resources provided by the one or more computing devices to the collaborative ML system, and track the allocation of resources using the smart contracts;
receive updated information on at least one of: the available computing resources provided by the one or more computing devices, and the collaborative ML system resource requirements; and
update the allocation of computing resources to the collaborative ML system based on the updated information, and track the updated allocation of resources using the smart contracts.

26. The system of claim 25, wherein at least one of the one or more computing devices is part of a communications network.

27. A non-transitory computer-readable medium comprising instructions which, when executed on a computer, cause the computer to perform the method of claim 1.
